(19) United States
(12) Patent Application Publication
(10) Pub. No.: US 2011/0096363 A1
(43) Pub. Date: Apr. 28, 2011

(54) IMAGE PROCESSING APPARATUS

(75) Inventors: Kunihisa Chiba, Osaka (JP); Takeshi Yamaguchi, Osaka (JP); Kazuyuki Ogita, Osaka (JP); Yoichi Kimura, Osaka (JP)

(73) Assignee: SHARP KABUSHIKI KAISHA, Osaka (JP)

(21) Appl. No.: 12/914,416

(22) Filed: Oct. 28, 2010

(30) Foreign Application Priority Data
Oct. 28, 2009 (JP) 2009-247602

(51) Int. Cl. G06K 15/00

(52) U.S. Cl. 358/1.16

(57) ABSTRACT

Image data is saved directly in an external memory without using an incorporated HDD for filing the image data and without degrading the image data, so that costs are reduced as not requiring the incorporated HDD and the image data without degradation is able to be used again easily. A USB memory saves image data acquired by an image processing apparatus and setting data of the image data, and further saves a tool software allowing the image data to be viewed, edited, and printed by a PC. The image data saved in a saving memory of the USB memory can be, for example, printed or transmitted as it is by the image processing apparatus. Further, the tool software allows a user to, for example, view and edit the image data using the PC. Further, it is possible to cause a specific printer to print the image data by the PC.

### CROSS-NOTING PARAGRAPH

This non-provisional application claims priority under 35 U.S.C. §119(a) on Patent Application No. 2009-247602 filed in JAPAN on Oct. 28, 2009, the entire contents of which are hereby incorporated herein by reference.

### FIELD OF THE INVENTION

The present invention relates to an image processing apparatus, more specifically, to an image processing apparatus having a document filing function of storing acquired image data in a predetermined storage medium.

### BACKGROUND OF THE INVENTION

Some image processing apparatuses such as printers and multifunction peripherals (MFPs) are provided with a so-called document filing function for storing image data. According to the document filing function, a storage medium, for example, such as an HDD (Hard disk drive) is incorporated in an image processing apparatus and image data that has been printed once is stored (filed) in the storage medium, so that the image data can be printed again or transmitted to an external apparatus later. Alternatively, the image processing apparatus is configured not to print printing image data that is received from a network-connected host at the time of the reception, but to store the printing image data until a user inputs a private code to an operation panel of the image processing apparatus, thereby strengthening the security.

In addition, some conventional image processing apparatuses configured as a multifunction peripheral provided with a scanner and the like, have a function of converting scanned image data into a PDF (Portable Document Format) file to save in a USB (Universal Serial Bus) memory, as processing of saving image data in a storage medium.

For example, Japanese Laid-Open Patent Publication No. 2009-171044 discloses a technology that, in a multifunction peripheral having a so-called Scan to USB function of saving image data read by a scanner in a USB memory, image file formats for saving are not limited to widely-used file formats such as bitmap, GIF and PDF, and original file formats may be also used.

Conventionally, when image data is saved in an image processing apparatus such as a printer or an MFP, an HDD that is incorporated in the image processing apparatus is necessary, and in an image processing apparatus incorporating no HDD, if a job of printing or the like is executed, it is impossible to save the image data with the document filing function.

In addition, in the image processing apparatus that incorporates an HDD, it is impossible to view a file saved in the HDD by a PC (Personal Computer), thus, in order to view image data, it is necessary to preview the image data using a display screen provided in the image processing apparatus or to scan a document again and take the image data in the image processing apparatus for editing.

Moreover, when it is desired to edit a file saved in the HDD with the document filing function, for example, when it is desired to print document image data scanned and saved by a user with a red circle added to a part of the document image data, there is an image processing apparatus that enables the operation by an operation panel thereof, but the operability is not necessarily good, and there is a problem that the operation panel is occupied during the operation. In addition, there has been no image processing apparatus that has a function of saving, in a recording medium, a tool software that allows image data filed with the document filing function to be viewed, edited (processed), and printed, together with the image data.

Moreover, in the case of the image processing apparatus having a function of converting scanned image data into a PDF file to save in a USB memory, image degradation is caused at the time when the image data is converted into the PDF, and it is impossible to save the image data itself read by a scanner.

In addition, in the technology described in Japanese Laid-Open Patent Publication No. 2009-171044, it is also impossible, when a file in an original format is saved in a USB memory, to view the file by a PC or to print the file from the PC by setting printing conditions. In addition, it is impossible to perform processing of printing image data saved in the USB memory by attaching the USB memory to an MFP (including other MFP). Further, even if a tool for viewing the image data saved in the USB memory is prepared, the tool is to be provided separately and a user needs to install the tool on the image processing apparatus when the tool is required, thus the situation where the user does not know where the tool is, is likely to occur.

### SUMMARY OF THE INVENTION

An object of the present invention is to provide an image processing apparatus, in which image data is saved directly in an external memory without using an incorporated HDD for filing the image data and without degrading the image data, so that costs are reduced as not requiring the incorporated HDD and the image data without degradation is able to be used again easily.

An object of the present invention is to provide an image processing apparatus, comprising; an image acquiring portion for acquiring image data; an image memory for temporarily storing the acquired image data; a document filing portion for performing processing of causing a predetermined storage medium to store the image data temporarily stored in the image memory; and an external memory interface to and from which an external memory is attachable and detachable, wherein the document filing portion uses the external memory attached to the external memory interface, as the predetermined storage medium, to save the image data temporarily stored in the image memory and setting data in which a characteristic of a predetermined setting item of the image data is set, directly in the external memory.

Another object of the present invention is to provide the image processing apparatus, wherein when saving the image data and the setting data in the external memory, the document filing portion saves a tool software realizing a function of performing displaying, editing, and printing of the image data, in the external memory, together with the image data and the setting data.

Another object of the present invention is to provide the image processing apparatus, wherein the tool software is a software operated by being read in a computer apparatus to which the external memory is attached, and realizes a function of developing the image data in a predetermined format to bitmap data to display on a screen of the computer apparatus, as well as, when causing the screen of the computer apparatus to display the bitmap data, realizes a function of reflecting setting data of a setting item affecting display, out of the setting data, in screen display of the computer apparatus.

Another object of the present invention is to provide the image processing apparatus, wherein when causing the screen of the computer apparatus to display the bitmap data, the tool software causes screen display of the computer apparatus to display setting data of a setting item not affecting display, out of the setting data.

Another object of the present invention is to provide the image processing apparatus, wherein when causing the screen of the computer apparatus to display the image data, the tool software realizes a function of editing the image data in response to a user operation for the computer apparatus, and returns the edited image data to the image data in the predetermined format again to store in the external memory, so that the image data after editing is able to be processed in the image processing apparatus to which the external memory is attached.

Another object of the present invention is to provide the image processing apparatus, wherein the tool software realizes a function in which the computer apparatus reads the image data and the setting data from the external memory and a specific printing apparatus is caused to print the image data in response to operating input to the computer apparatus.

Another object of the present invention is to provide the image processing apparatus, wherein at least one of mobile recording mediums including a USB memory and an external HDD is attachable and detachable to and from the external memory interface.

Another object of the present invention is to provide the image processing apparatus, wherein the image data saved in the external memory is saved in a format originally determined corresponding to the image processing apparatus.

### BRIEF DESCRIPTION OF THE DRAWINGS

FIG. 1 is an explanatory diagram of an exemplary configuration of an image processing apparatus according to the present invention;

FIG. 2 is an explanatory diagram of exemplary processing of saving document filing data by a copying job in a USB memory, in the image processing apparatus according to an embodiment of the present invention;

FIG. 3 is an explanatory diagram of exemplary processing of document filing data;

FIG. 4 is an explanatory diagram of the state where document filing data is viewed by a software tool;

FIG. 5 is an explanatory diagram of the state where document filing data is edited by the software tool; and

FIG. 6 is an explanatory diagram of the state where document filing data is printed by the software tool.

### PREFERRED EMBODIMENTS OF THE INVENTION

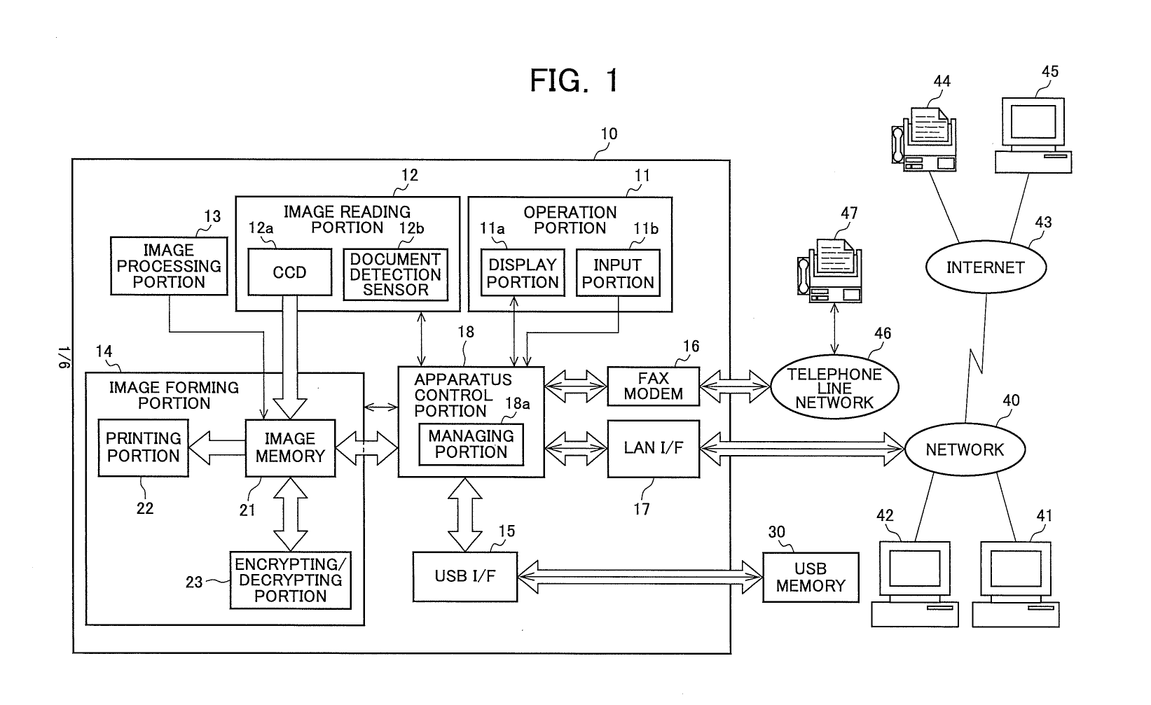

FIG. 1 is an explanatory diagram of an exemplary configuration of an image processing apparatus according to the present invention. In FIG. 1, the solid arrow shows the signal line and the outline arrow shows the data line.

An image processing apparatus 10 is connected to a telephone line network 46 and a network 40, and further connected to an internet 43 through the network 40. A facsimile apparatus (FAX) 47 is connected to the telephone line network 46, and a FAX 44 and a terminal apparatus 45 such as a PC are connected to the internet 43. In addition, terminal apparatuses 41 and 42 are connected to the network 40. The image processing apparatus 10 is capable of facsimile communication with the FAXes 44 and 47, and is capable of transmitting/receiving various data including image data using an e-mail or the like, to/from the terminal apparatuses 45, 41, and 42. The configuration of the networks and the configuration of the connecting external apparatuses show an example of a communication system in which the image processing apparatus 10 is connected.

The image processing apparatus 10 is configured as an MFP having, for example, a scanner function, a copying function, a facsimile function, a printer function and the like, and includes an operation portion 11, an image reading portion 12, an image processing portion 13, an image forming portion 14, a USB interface (USB I/F) 15, a FAX modem 16, a LAN interface (LAN I/F) 17, and an apparatus control portion 18.

The apparatus control portion 18 substantially is a computer and includes a CPU, a RAM, and a ROM. The ROM functions as a managing portion 18a for storing control information of an image processing apparatus, various setting data, and the like. The apparatus control portion 18 executes various computer programs in response to instructions from the operation portion 11 and the like, thereby controlling operations of respective components of the image processing apparatus 10. The various computer programs described above have been stored in the ROM of the managing portion 18a in advance.

In the embodiment according to the present invention, image data that is temporarily stored in an image memory 21 is able to be saved directly in a USB memory 30, without using an incorporated HDD. Accordingly, the configuration without having an incorporated HDD is enabled, thus making it possible to reduce costs. Programs and data conventionally stored in an incorporated HDD are able to be stored in another storage portion such as the ROM of the apparatus control portion 18.

The operation portion 11 is comprised of an operation panel in which an input portion 11b that includes a touch panel having various input keys and the like, and a display portion 11a such as a liquid crystal display, are stacked. In the operation portion 11, an image of operating keys is displayed on the display portion 11a and the coordinates of the position of the operating keys touched by a user on the input portion 11b are obtained, thereby recognizing the operation of the image processing apparatus 10 and instructions by the user to various settings. In addition, by outputting a control signal corresponding to the instruction by the user to the apparatus control portion 18, processing corresponding to the input operation by the user may be realized.

The image reading portion 12 has an optical system including a document detection sensor 12b and a CCD line sensor 12a. According to the image reading portion 12, at the time of copying or scanning a document, image information is read from the document mounted on a document platen by the document detection sensor 12b and the read image information is converted into electric signals by the CCD line sensor 12a to output as image data to the image memory 21.

The image processing portion 13 executes image processing such as gamma correction processing or filtering processing, or various processing such as compression or decompression, for image data input from the image reading portion 12 or an external apparatus to the image memory 21, and once outputs the image data applied with the processing to the image memory 21 page by page to store in the image memory 21 temporarily.

The image forming portion 14 is provided with the image memory 21, a printing portion 22, and an encrypting/decrypting portion 23. In response to instructions from the apparatus control portion 18 and the like, the image memory 21 temporarily stores image data to be transmitted to the printing portion 22 page by page, and outputs the stored image data in synchronization with image formation by the printing portion 22. As the image memory 21 processes the image data page by page successively, even when there are a plurality of image data to be transmitted to the printing portion 22, it is possible to perform image forming operations efficiently and quickly.

The printing portion 22 includes a photoreceptor, a charging device, a laser scanning unit, a developing device, a transfer unit, a cleaning device, a fixing device, a paper feed tray and the like, and forms an image based on the image data transmitted from the image memory 21, on recording paper, in response to instructions from the apparatus control portion 18 and the like. In addition, the encrypting/decrypting portion 23 performs encrypting processing or decrypting processing for the image data input to the image memory 21, in accordance with predetermined encrypting or decrypting algorithm.

The USB I/F 15 is an interface (external memory interface) provided with a USB port, and automatically recognizes the USB memory 30 attached to the USB port. The image data temporarily stored in the image memory 21 is accumulated in the USB memory 30 through the USB I/F 15. In addition, it is possible to read image data and the like saved in the USB memory 30 through the USB I/F 15 to store in the image memory 21 temporarily. The USB memory 30 is one mode of the external memory according to the present invention, and in a case where an external memory of another system is used, an interface in accordance with the system is provided.

The image processing apparatus 10 is connected to the telephone line network 46 through the FAX modem 16, and is capable of facsimile communication with the FAX 47. In addition, the image processing apparatus 10 is connected to the network 40 through the LAN I/F 17, is capable of facsimile communication with the FAX 44, and is further capable of data communication with the terminal apparatuses 41, 42, and 45.

By operating respective components described above, the image processing apparatus 10 is able to execute, in response to instructions by the input operation of a user from the operation portion 11 or instructions from the external apparatus and the like, a copying job for reading a document image to print on recording paper, a printing job for receiving image data transmitted from the external apparatus and the like to print on recording paper, a scanning job for reading a document image to transmit to the external apparatus and the like, a FAX job for performing facsimile communication, a document filing job for filing image data read by the image reading portion 12 or image data transmitted from the external apparatus, and the like.

Note that, an image acquiring portion according to the present invention has a function of acquiring image data, and corresponds to parts, such as the image reading portion 12 and the USB I/F 15 or the FAX modem 16 and the LAN I/F 17, capable of acquiring a document or image data from the external apparatus. Further, a document filing portion according to the present invention corresponds to the apparatus control portion 18 realized by a computer.

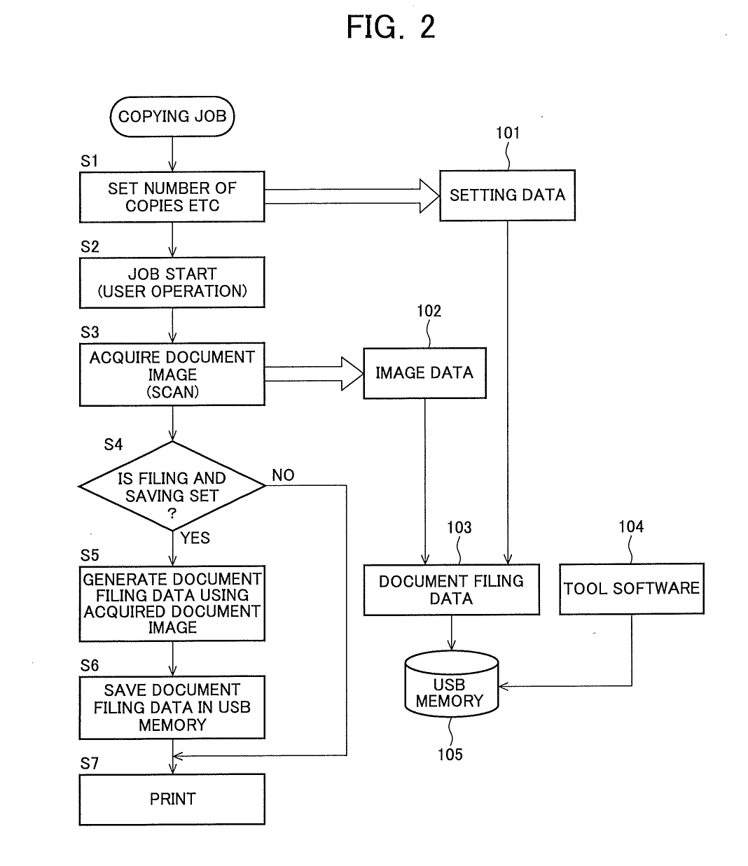

Next, description will be given for processing when a user causes the image processing apparatus 10 to execute a copying job to save document filing data in the USB memory 30, as an example of processing of the image processing apparatus 10. Here, description will be given for exemplary processing, with reference to the configuration of FIG. 1, in accordance with the flowchart of FIG. 2.

In the copying job, a user attaches the USB memory 30 to the USB I/F 15. Then, the user places a document on the document platen of the image reading portion 12, and sets to perform filing and saving, at the same time, sets setting items such as the number of printing (copying) copies as appropriate (S1). In order to perform such setting, a predetermined setting item may be provided as a special function of the image processing apparatus 10, or at the time when the USB memory 30 is attached, a pop-up message or the like indicating whether to perform filing and saving for the USB memory 30 may be displayed on the display portion 11a for selection by the user. Alternatively, if performing more automatically, it may be configured such that filing and saving for the USB memory 30 is enabled by default, at the time when the USB memory 30 is attached to the USB I/F 15.

In any case, the above-described processing allows the image processing apparatus 10 to know that the image data by the copying job executed by the user needs to be filed and saved in the USB memory 30. When setting is completed, the user presses a copying start button displayed on the operation portion 11 to start the copying job (S2).

Upon receiving the instruction to start the copying job, the image processing apparatus 10 performs scanning of the document image by the image reading portion 12, and acquires the document image as image data 102 to save in the image memory 21 (S3). When acquirement of the image data 102 is completed, it is judged whether or not filing of the acquired image data 102 is specified (S4). Here, since such setting is performed by the setting processing at S1 above that the image data by the copying job is filed and saved in the USB memory 30, the image processing apparatus 10 generates document filing data 103 using the acquired image data 102 (S5). The document filing data 103 is obtained by combining the acquired document image data 102 and setting data 101. The setting data 101 is one in which a characteristic of the image data is set to a predetermined setting item, and acquired from, for example, setting values set by the user for each job, such as the number of copying copies by the copying job, and setting values of the image processing apparatus 10 itself, such as vividness of a printing image.

Then, the image processing apparatus 10 saves the generated document filing data 103 in the USB memory 30 (S6). When taken in the image processing apparatus 10 again, the document filing data 103 saved in the USB memory 30 is able to be used for reoperations such as reprinting and retransmission.

After saving the document filing data 103 in the USB memory 30, the image processing apparatus 10 prints the image data saved in the image memory 21 by the printing portion 22 (S7). Whereby, the copying job is completed. Alternatively, when filing and saving for the USB memory 30 is not set at S4, the flow goes to S7 and the image data 102 saved in the image memory 21 is printed by the printing portion 22.

Further, in the image processing apparatus 10 of this embodiment, a tool (application) software 104 allowing the document filing data 103 to be viewed, edited, and printed by a PC, is saved in the USB memory 30. The tool software 104 is saved in a predetermined saving location, for example, when the image processing apparatus 10 is manufactured. The location where the tool software 104 is saved in advance is not particularly limited, but the ROM of the managing portion 18a may be used.

When saving the document filing data 103 in the USB memory 30, the image processing apparatus 10 saves the above-described tool software 104 in the UBS memory 30 at the same time.

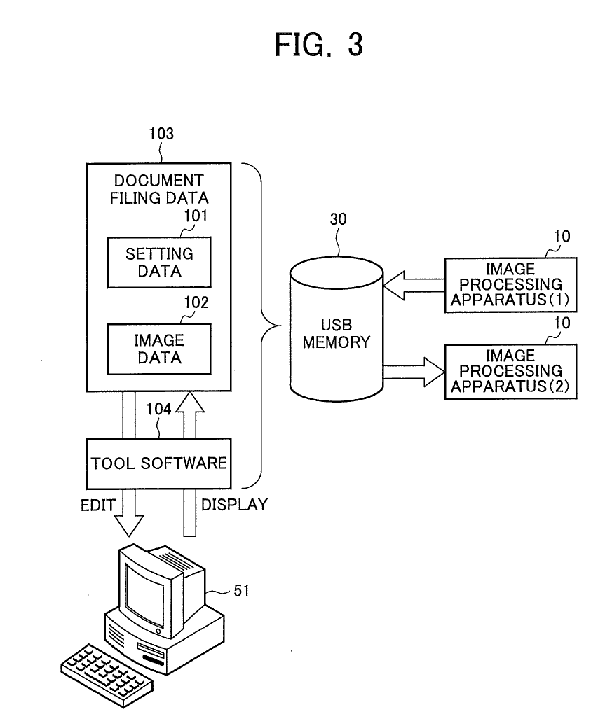

FIG. 3 is an explanatory diagram of exemplary processing of document filing data.

The image data 102 of the document filing data 103 saved in the USB memory 30 is fundamentally file data for reprinting or retransmission, and therefore is able to be reprinted or retransmitted by reading to the image processing apparatus 10 again. At this time, it is possible to perform reprinting or retransmission without requiring a PC 51. Here, an incorporated HDD that has been conventionally required to perform document filing in the image processing apparatus 10 becomes unnecessary, thus making it possible to reduce costs for the image processing apparatus 10. Further, when the image data 102 saved in the USB memory 30 is reprinted or printed by another comparable apparatus, it is possible to perform reprinting without deteriorating image quality of the image data.

In addition, by saving the tool software 104 allowing the image data 102 to be viewed, edited, and printed by the PC 51, in the USB memory 30 together with the document filing data 103, a user is able to view the image data 102 using the PC 51 to confirm contents thereof even without the image processing apparatus 10, before actually operating the saved document filing data 103 again. Moreover, by saving the tool software 104 together with the document filing data 103, the user's trouble of searching the tool software 104 becomes unnecessary, differently from the case where the tool software 104 is provided separately.

Note that, description has been given in the above-described example for the processing of saving the document filing data in the USB memory 30 in the copying job, but the filing processing in the embodiment according to the present invention is not limited to the processing in the copying job, and is applicable to, for example, processing of, in the printing job for printing image data transmitted from the external apparatus by the printing portion 22, saving the image data in the USB memory 30, processing of transmitting image data acquired by scanning to the external apparatus by FAX or a mail etc., and the like.

In addition, the external memory is not limited to the USB memory 30, other external mobile memory such as a memory card, or one applied with an incorporated HOD drive or the like that is externally connected to the image processing apparatus 10 may be applied, and at least one mobile recording medium that is known may be applied. This is the same in the exemplary processing described below.

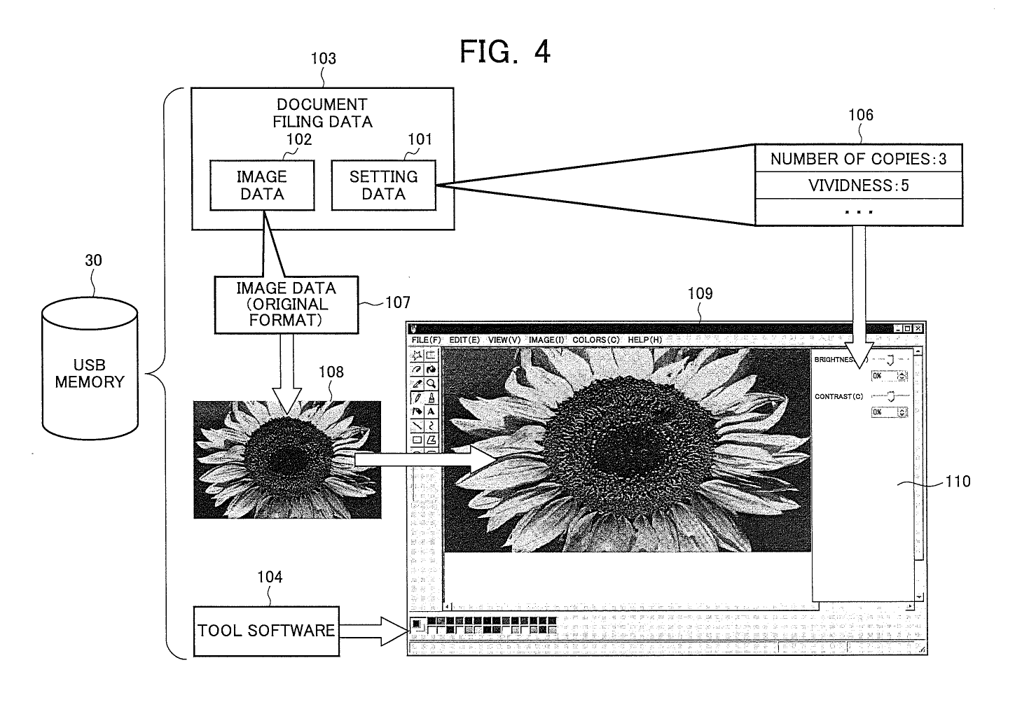

FIG. 4 is an explanatory diagram of the state where document filing data is viewed by the software tool. The document filing data 103 is composed of the image data 102 based on a given format and the setting data 101 including the number of printing copies of the image data. Here, the tool software 104 allows an image to be displayed on a screen of a PC, by developing the format of the image data 102 to bitmap information. In addition, at the time of displaying the image, it is also possible to reflect the color state and the like in the display screen, based on data of “brightness” included in the setting data 101 and the like. It is also possible to display information unrelated to image appearance, such as the number of copies included in a job ticket, in numerical terms and the like.

As described above, the image processing apparatus 10 saves the document filing data 103 in the USB memory 30 as well as saves the tool software 104 having a function of causing the document filing data 103 to be viewed, edited, and printed by a PC, in the USB memory 30. Here, using of the USB memory 30 enables to copy the document filing data 103 and the tool software 104 in the PC. In addition, it is possible to execute the tool software 104 in the PC and open the document filing data 103 by the tool software 104.

The document filing data 103 is composed of the setting data 101 saving a setting value 106 such as the number of printing copies and brightness, and the image data 102 serving as a source of a job thereof. Here, since the image data 102 is image data in an original format 107, not in a JPEG or bitmap format that is generally used, and therefore, can not be displayed on a PC as it is However, since the tool software 104 is able to interpret the data structure of the above-described original format 107, the image data 102 in the original format 107 is able to be converted into bitmap data 108 in the format that is able to be displayed commonly. In addition, by causing a display screen 109 by the tool software 104 to display the converted bitmap data 108, a user is able to confirm what image the image data 102 of the document filing data 103 has.

The setting item affecting image appearance, out of setting items to which the setting value 106 of the setting data 101 is set, is able to be reflected in the display screen 109 by the tool software 104. For example, the setting item “brightness” of the setting value 106 is able to be reflected as follows.

Since the bitmap data 108 is able to express toned color, if “brightness” has a setting range of “minimum value 1, maximum value 10”, a standard value is “5”, and the setting value 106 of “brightness” of the setting data 101 is “6”, brightness of the setting value 106 is enhanced by 20% compared to the standard value. Accordingly, when the bitmap data 108 to be displayed is generated, the bitmap data 108 is generated with each color tone enhanced by 20% compared to one that is obtained by converting an original image directly to bitmap, to be displayed on the display screen 109. This makes it possible to reflect the setting value 106 of brightness in the display screen 109 on a PC. It is also possible to display the bitmap data 108 as well as the setting value 106 of the setting data 101 in a setting value display area 110 in numerical terms, on the display screen 109.

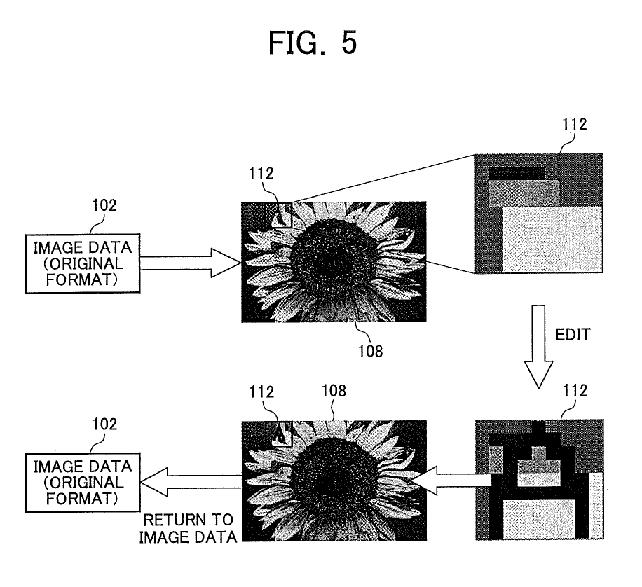

FIG. 5 is an explanatory diagram of an editing function of the tool software 104.

The image data 102 is able to be edited as appropriate using the tool software 104. In this case, the image data 102 in the original format is developed to the bitmap data 108 once. Since the tool software 104 interprets the image data 102 in the original format, the image data 102 is able to be displayed by converting into the bitmap data 108. In addition, since the bitmap data 108 indicates what color a pixel at each position has, by specifying at which coordinates of pixel is to be changed and to what color to be changed, a user is able to change the image of the bitmap data 108. For example, in the example of FIG. 5, taking notice of an arbitrary data area 112 of the bitmap data 108, the data area 112 is subjected to arbitrary editing by the user operation and thereafter can be returned to the image data 102.

Whereby, editing of the image is enabled, regardless of contents (purpose) of editing, such as synthesizing another image, attaching text data, adding the line, or attaching a stamp image, with respect to the bitmap data 108. In addition, the edited bitmap data 108 is returned to the image data 102 in the former original format 107 and saved, so as to be able to be reflected in the document filing data 103.

It is also possible to change the setting value 106 of brightness, the number of printing copies and the like, of the setting data 101. For example, an operation is possible to change the number of printing copies from “1” to “10”, and the like. Moreover, when brightness is changed, it is possible that the result of the change is reflected in the bitmap data 108 that is currently displayed and instantly reflected in the display screen 109. In this manner, since the change is reflected for the document filing data 103 itself, the change is also applied in the reoperation when the document filing data 103 is reprinted or retransmitted by the image processing apparatus 10. For example, when the image data 102 is processed with text attached thereto, the image attached with the text is printed in reprinting, or when the number of printing copies is changed from 1 to 10, 10 copies are able to be printed in reprinting.

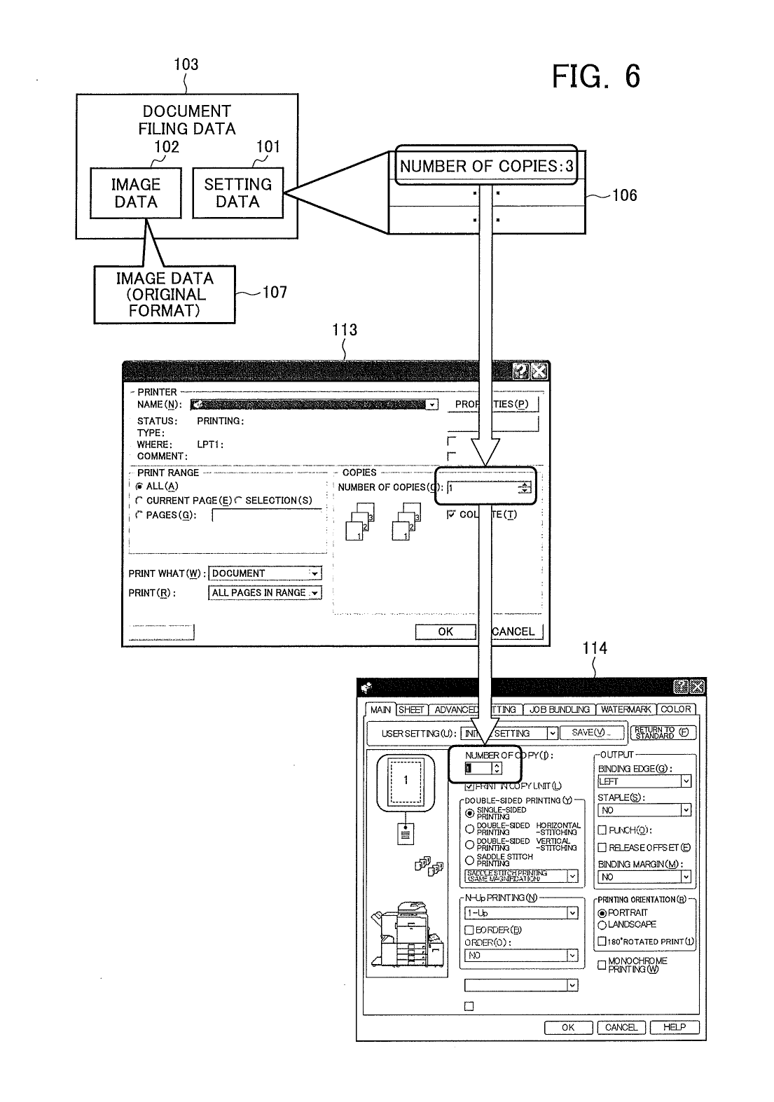

FIG. 6 is an explanatory diagram of a printing function of the tool software 104. The document filing data 103 is file data in an original format used by the image processing apparatus 10 for reprinting and retransmission, and is able to be reprinted without using a PC or the like, if being able to be taken in the image processing apparatus 10.

In addition, the document filing data 103 is also able to be printed by the tool software 104. At this time, since the tool software 104 is able to acquire a setting value such as the number of copies from the setting data 101 of the document filing data 103, the setting value is inherited at a printer driver to perform setting of the number of copies or the like automatically. For example, on setting screens 113 and 114 of the printer driver, information of the number of copies acquired from the setting data 101 is displayed, further it is possible to edit the number of copies on the setting screen 113. When a user operates the setting screens 113 and 114 of the printer driver, it is possible to cause a specific printer connected to a PC to print the document filing data 103. This printer may be the image processing apparatus 10.

As above, according to the present invention, it is possible to provide an image processing apparatus, in which image data is saved directly in an external memory without using an incorporated HDD for filing the image data and without degrading the image data, so that costs are reduced as not requiring the incorporated HDD and the image data without degradation is able to be used again easily.

Further, according to the present invention, by loading document filing data that is saved in the external memory again into the image processing apparatus, it is possible to perform reoperations such as reprinting and retransmission. In addition, before actually operating image data saved in the external memory again, even without the image processing apparatus, it is possible to confirm contents by viewing the image data by a computer apparatus such as a PC. In the present invention, by causing the external memory to save a tool software realizing the function for such processing together with image data, it is possible to omit the trouble of searching the tool software, differently from the case where the tool software is provided separately.

Further, according to the present invention, by utilizing not only simple image data but also setting data in which a predetermined characteristic of image data is set, it is possible to bring the display state closer to the actual state. In addition, by displaying setting of the number of printing copies of image data and the like on a computer apparatus such as a PC in numerical terms and the like, it is possible to confirm by a PC or the like whether or not there is a problem in setting of document filing data, before processing image data by the actual image processing apparatus.

Further, according to the present invention, when a user desires to apply some edits to image data stored in the external memory, it is possible to conduct the editing operation by a computer apparatus such as a PC. In addition, the computer apparatus such as a PC that has read image data from the external memory allows a printer connected to the computer apparatus to print the image data.

1. An image processing apparatus, comprising;
an image acquiring portion for acquiring image data;
an image memory for temporarily storing the acquired image data;
a document filing portion for performing processing of causing a predetermined storage medium to store the image data temporarily stored in the image memory; and
an external memory interface to and from which an external memory is attachable and detachable, wherein
the document filing portion uses the external memory attached to the external memory interface, as the predetermined storage medium, to save the image data temporarily stored in the image memory and setting data in which a characteristic of a predetermined setting item of the image data is set, directly in the external memory.

2. The image processing apparatus as defined in claim 1, wherein
when saving the image data and the setting data in the external memory, the document filing portion saves a tool software realizing a function of performing displaying, editing, and printing of the image data, in the external memory, together with the image data and the setting data.

3. The image processing apparatus as defined in claim 2, wherein
the tool software is a software operated by being read in a computer apparatus to which the external memory is attached, and realizes a function of developing the image data in a predetermined format to bitmap data to display on a screen of the computer apparatus, as well as, when causing the screen of the computer apparatus to display the bitmap data, realizes a function of reflecting setting data of a setting item affecting display, out of the setting data, in screen display of the computer apparatus.

4. The image processing apparatus as defined in claim 3, wherein
when causing the screen of the computer apparatus to display the bitmap data, the tool software causes screen display of the computer apparatus to display setting data of a setting item not affecting display, out of the setting data.

5. The image processing apparatus as defined in claim 3, wherein
when causing the screen of the computer apparatus to display the image data, the tool software realizes a function of editing the image data in response to a user operation for the computer apparatus, and returns the edited image data to the image data in the predetermined format again to store in the external memory, so that the image data after editing is able to be processed in the image processing apparatus to which the external memory is attached.

6. The image processing apparatus as defined in any one of claims 3 to 5, wherein
the tool software realizes a function in which the computer apparatus reads the image data and the setting data from the external memory and a specific printing apparatus is caused to print the image data in response to operating input to the computer apparatus.

7. The image processing apparatus as defined in claim 1, wherein
at least one of mobile recording mediums including a USB memory and an external HDD is attachable and detachable to and from the external memory interface.

8. The image processing apparatus as defined in claim 1, wherein
the image data saved in the external memory is saved in a format originally determined corresponding to the image processing apparatus.
